(19) United States
(12) Patent Application Publication
(10) Pub. No.: US 2015/0009307 A1
(43) Pub. Date: Jan. 8, 2015

(54) STEREOSCOPIC IMAGE DISPLAY DEVICE

(71) Applicant: Samsung Electronics Co., Ltd., Gyeonggi-do (KR)

(72) Inventors: Ho-Min Lee, Chungcheongnam-do (KR); Sung-Soon Kim, Seoul (KR); Joong-Wan Park, Gyeonggi-do (KR)

(73) Assignee: Samsung Electronics Co., Ltd., Gyeonggi-do (KR)

(21) Appl. No.: 14/359,982

(22) PCT Filed: Nov. 23, 2012
(86) PCT No.: PCT/KR2012/009971

§ 371 Date: May 22, 2014

(30) Foreign Application Priority Data
Nov. 23, 2011 (KR) 10-2011-0123239

(51) Int. Cl. H04N 13/04; G02B 27/22

(52) U.S. Cl. CPC H04N 13/0402; H04N 13/0452; H04N 13/0497; G02B 27/2242
USPC 348/54

(57) ABSTRACT

The present invention relates to a stereoscopic image display device. A stereoscopic image display device according to one aspect of the present invention comprises: a backlight unit including a left-eye light source; a display panel unit for receiving light from the backlight unit and displaying the light in 2D images or 3D images; a double-sided prism film arranged to face the backlight unit and emit light at a predetermined angle toward the display panel unit; and a switchable diffuser interposed between the display panel unit and the double sided prism film and turned on/off depending on whether it is a 2D mode or a 3D mode to emit light having different viewing angles.

### TECHNICAL FIELD

The present invention relates to an autostereoscopic display device, and more particularly to an autostereoscopic display device which can improve a spatial uniformity during a 2D mode and prevent cross-talks introduced to the left eye and the right eye during a 3D mode.

### BACKGROUND ART

A general method for realizing a three-dimensional image is to use binocular disparity of a user. Methods of realizing a three-dimensional image using a binocular disparity include a stereoscopic method and an autostereoscopic method.

The stereoscopic method is a method of wearing glasses for displaying a three-dimensional image such as polarization glasses or LC shutter glasses. The stereoscopic method is applied at a place, such as a theater, where many people watch a movie by using a polarized projector. The autostereoscopic method is a method of visually observing an image using an apparatus such as a lenticular lens, a parallax barrier, and a parallax illumination. The autostereoscopic method is applied to a gaming display, a home TV, and an exhibition display used by an individual or a small number of people.

The technologies of the autostereoscopic method according to the present invention are disclosed in Korean Patent Application Publication No. 10-2011-0036916 (published on Apr. 12, 2011 and entitled “Autostereoscopic display device) and Korean Patent Application Publication No. 10-2011-0016461 (published on Feb. 17, 2011 and entitled “Optical Device and Autostereoscopic Display Device Including Optical Device”).

Further, in recent years, electronic devices using both a 2D mode and a 3D mode have been developed. A 2D/3D compatible display device according to the related art is disclosed in Korean Patent Application Publication No. 10-2009-0047070 (published on May 12, 2009 and entitled “2D/3D Convertible Display Device and Method”).

However, in the case of a 3D mode using a parallax barrier method, eyes may be easily fatigued and the apparatus is not suitable for a long-time use due to a problem such as a narrow sweet spot or a view reversal. In order to solve the problem, a 3D technology using a directional backlight has been studied.

The 3D technology using a directional backlight according to the related art is disclosed in Korean Patent Application Publication No. 10-2010-0139017 (published on Dec. 31, 2010 and entitled “Glasses Free Autostereoscopic Display Having Fresnel Lens Element”).

However, in the 3D mode using a directional backlight according to the related art, a Moire phenomenon may be generated by an interference between a pixel of an LCD panel and a pattern of a light guide plate.

Further, in the 3D mode using a directional light source, a diffuser cannot be used as the left and right-eye images should be separated by forming a narrow view angle of the left and right images. Accordingly, when the display apparatus is used in the 2D mode, spatial uniformity is lowered and a black band phenomenon is generated. Further, when a diffuser is used, a cross-talk phenomenon in which the left and right-eye images are mixed may become severe.

### DETAILED DESCRIPTION OF THE INVENTION

### Technical Problem

Therefore, the present invention provides an autostereoscopic display device which can improve spatial uniformity in a 2D mode and prevent a cross-talk of an image introduced into the left eye and the right eye during a 3D mode, by using a switchable diffuser.

### Technical Solution

In accordance with an aspect of the present invention, there is provided an autostereoscopic display device including: a backlight unit including a left-eye light source, a right-eye light source, and a light guide plate for directionally emitting light of the left-eye light source and the right-eye light source; a display panel unit for receiving light of the backlight unit and displaying a 2D image or a 3D image; a double-sided prism film provided to face the backlight unit, for outputting light toward the display panel unit at a predetermined angle; and a switchable diffuser located between the display panel unit and the double-sided prism film, for outputting light switched on or off according to a 2D mode or a 3D mode to have different view angles.

Preferably, the backlight unit includes a backlight driving unit for alternately emitting light of the left-eye light source and the right-eye light source, and wherein the display panel unit further includes a panel driving unit for synchronizing the left and right-eye images with left and right-eye image transmitting timings.

More preferably, during the 2D mode, the panel driving unit is driven to transmit the left and right-eye images to the display panel unit together at the left-eye image transmitting timing and the right-eye image transmitting timing, and during the 3D mode, the panel driving unit is driven to transmit the left-eye image to the display panel unit at the left-eye transmitting timing and the right-eye image to the display panel at the right-eye transmitting timing, respectively.

More preferably, the switchable diffuser includes: substrates provided to face each other; electrodes formed on the substrates to face each other; and a polymer dispersed liquid crystal layer formed between the electrodes and including a polymer and liquid crystal.

More preferably, if a power source to the switchable diffuser is switched off, light input to the switchable diffuser is scattered by the polymer dispersed liquid crystal layer and light having a wide view angle due to the scattered light displays a 2D image through the display panel unit, and if the power source to the switchable diffuser is switched on, light input to the switchable diffuser directly transmits the polymer dispersed liquid crystal layer along a light emission direction to have a narrow view angle and the light having the narrow view angle displays a 3D image through the display panel unit.

More preferably, the switchable diffuser further includes a switch for switching on or off the switchable diffuser according to the 2D mode or the 3D mode.

More preferably, the autostereoscopic display device further includes a controller for controlling application of a voltage to the backlight driving unit, the switch, and the panel driving unit.

More preferably, the autostereoscopic display device further includes a bonding part provided between the switchable diffuser and the display panel unit to restrict a refractive index of light emitted from the backlight unit from lowering.

More preferably, the bonding part includes an Optically Clear Adhesive (OCA) or a Super View Resin (SVR).

The switchable diffuser further includes a coating layer for restricting lowering of a refractive index of light emitted from the backlight unit.

More preferably, the coating layer is formed on at least one surface of the switchable diffuser.

More preferably, the coating layer includes an Anti-Reflection (AR) coating layer and a Low Reflection (LR) coating layer.

More preferably, the switchable diffuser includes at least one of Polymer Dispersed Liquid Crystal (PDLC), Polymer Stabilized Cholesteric Texture (PSCT), and Suspended Particle Device (SPD).

In accordance with another aspect of the present invention, there is provided an autostereoscopic display device including: a light emitting member for outputting directional light; a display panel unit for displaying an 2D or 3D image with the emitted light; and a switchable diffuser located between the light emitting member and the display panel unit, for outputting light at a view angle of a 2D or 3D image according to switching-on or switching-off thereof.

Preferably, if a power source to the switchable diffuser is switched off, light input to the switchable diffuser is scattered to a wide view angle such that a 2D image is displayed through the display panel unit, and if the power source to the switchable diffuser is switched on, light input to the switchable diffuser transmits the switchable diffuser along a light emission direction to have a narrow view angle and the light having the narrow view angle displays a 3D image through the display panel unit.

More preferably, the switchable diffuser includes at least one of Polymer Dispersed Liquid Crystal (PDLC), Polymer Stabilized Cholesteric Texture (PSCT), and Suspended Particle Device (SPD).

More preferably, the autostereoscopic display device further includes a controller for controlling the switchable diffuser, the light emitting member, and the display panel unit according to a 2D mode or a 3D mode.

More preferably, the autostereoscopic display device further includes a bonding part provided between the switchable diffuser and the display panel unit to restrict a refractive index of light emitted from the light emitting member from lowering.

More preferably, the bonding part includes an Optically Clear Adhesive (OCA) or a Super View Resin (SVR).

More preferably, a coating layer for restricting lowering of a refractive index of light emitted from the backlight unit is formed on at least one surface of the switchable diffuser.

More preferably, the coating layer includes an Anti-Reflection (AR) coating layer and a Low Reflection (LR) coating.

### Advantageous Effects

As described above, the present invention can realize an image having an improved spatial uniformity in a 2D mode and realize an image which can prevent a view reversal phenomenon due to a cross-talk of an image in a 3D mode, by selectively applying a switchable diffuser according to a 2D or 3D mode.

Further, the present invention can prevent a black band phenomenon generated in a display panel unit and a Moire phenomenon during a 2D mode by a switchable diffuser.

Further, the present invention can prevent lowering of a resolution of an image during a 3D mode.

Further, the prevent invention can ensure a high transmissivity by bonding an Optically Clear Adhesive (OCA) or a Super View Resin (SVR) to restrain lowering of the transmissivity of light emitted from the backlight unit.

Further, the present invention has an effect of bonding a switchable diffuser to a display panel unit through a bonding part by Anti-Reflection (AR) coating or Low-Reflection (LR) coating one or opposite surfaces of the switchable diffuser when the switchable diffuser is disposed below a display panel unit. Further, the present invention restrains lowering of transmissivity of light emitted from a backlight unit by coating layers of one surface or opposite surfaces of a switchable diffuser. Thus, the present invention has an effect in which light emitted from a backlight unit has a high transmissivity without lowering the transmissivity.

### BRIEF DESCRIPTION OF THE DRAWINGS

FIG. 1 is a sectional view schematically showing an autostereroscopic display device according to an embodiment of the present invention;

FIG. 2 is a block diagram of the autostereoscopic display device according to the embodiment of the present invention;

FIG. 3 is a timing diagram of the autostereoscopic display device according to the embodiment of the present invention;

FIG. 4 is a view schematically showing a switchable diffuser of the autostereoscopic display device according to the embodiment of the present invention;

FIG. 5 is a view showing on/off states of the switchable diffuser of the autostereoscopic display device according to the embodiment of the present invention;

FIG. 6 is a view schematically showing a driving state of a 2D mode of the autostereoscopic display device according to the embodiment of the present invention;

FIG. 7 is a view schematically showing a driving state of the switchable diffuser in a 2D mode of the autostereoscopic display device according to the embodiment of the present invention;

FIG. 8 is a view schematically showing a driving state of a 3D mode of the autostereoscopic display device according to the embodiment of the present invention;

FIG. 9 is a view schematically showing a driving state of the switchable diffuser in a 3D mode of the autostereoscopic display device according to the embodiment of the present invention;

FIG. 10 is a view showing a state in which the switchable diffuser is bonded to a display panel unit by a bonding part in the autostereoscopic display device according to the embodiment of the present invention; and

FIG. 11 is a view showing a state in which a coating layer is formed in the switchable diffuser of the autostereoscopic display device according to the embodiment of the present invention.

### MODE FOR CARRYING OUT THE INVENTION

Hereinafter, an autostereoscopic display device according to an embodiment of the present invention will be described with reference to the accompanying drawings. In the process, thicknesses of lines and sizes of constituent elements shown in the drawings may be exaggerated for clearness and convenience of description thereof. The following terms are defined in consideration of their functions in the present invention, and may be changed according to an intention or custom of a user or a manager. Therefore, the definitions of the terms should be made based on the contents over the entire specification.

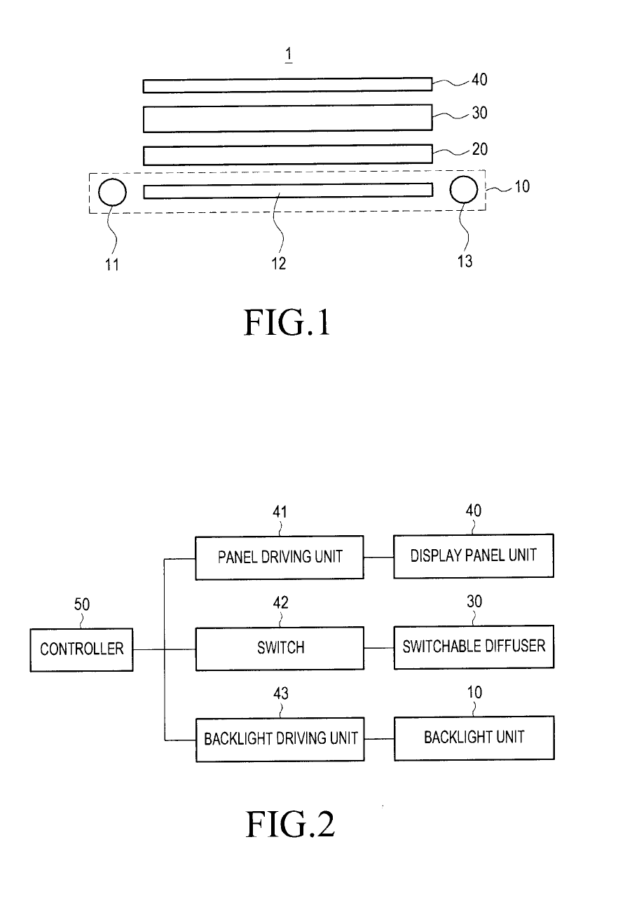

FIG. 1 is a sectional view schematically showing an autostereroscopic display device according to an embodiment of the present invention. FIG. 2 is a block diagram of the autostereoscopic display device according to the embodiment of the present invention. Referring to FIGS. 1 and 2, the autostereoscopic display device 1 according to the embodiment of the present invention includes light emitting members 10 and 20, a display panel unit 40, a switchable diffuser 30.

The light emitting members 10 and 20 include a backlight unit 10 and a double-sided prism film 20. The light emitting members 10 and 20 are located on a rear surface of the display panel unit 40, and output directional light toward the display panel unit 40, which will be described below.

Left-eye and right-eye light sources 11 and 13 are provided on the left and right sides of a light guide plate 12. The left-eye light source 11 emits light from the left side of the light guide plate 12 to the light guide plate 12 to provide a left-eye image to the display panel unit 40. The right-eye light source 13 emits light from the right side of the light guide plate 12 to the light guide plate 12 to provide a right-eye image to the display panel unit 40. The light guide plate 12 receives light of the left-eye and right-eye light sources 11 and 13 and outputs directional light to the double-sided prism film 20. The backlight unit 10 includes a backlight driving unit 14 for adjusting driving of the backlight unit 10, and the backlight driving unit 14 is operated under the control of the controller 50, which will be described below. The backlight driving unit 14 drives the left-eye light source 11 and the right-eye light source 13 in correspondence to a panel driving unit 41, which will be described below, irrespective of a 2D mode or a 3D mode.

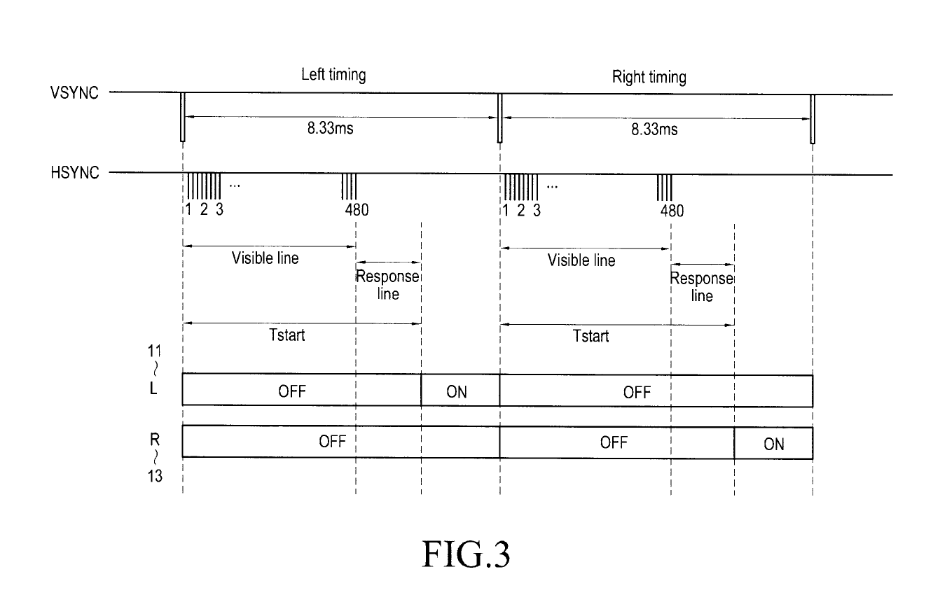

During the 2D mode, the backlight driving unit 14 drives the left and right light sources 11 and 13 such that the left and right images are transmitted to the left and right-eye image transmission timings of the display panel unit 40 together, and during the 3D mode, the backlight driving unit 14 is driven such that the left and right images are transmitted according to the left and right-eye image transmission timings of the display panel unit 40 (see FIG. 3).

The double-sided prism film 20 is provided to face the backlight unit 10, and is provided to face the light guide plate 12 in the embodiment of the present invention. The double-sided prism film 20 outputs the light input from the light guide plate 12 to the display panel unit 40. The double-sided prism film 20 converts the light into directional light and outputs the directional light. That is, the double-sided prism film 20 changes the view angle of the light into a narrow one of directional light such that the left and right images are provided to the left eye and the right eye of the user, and outputs the directional light to the switchable diffuser 30, which will be described below.

FIG. 3 shows a timing diagram of the autostereoscopic display device according to an embodiment of the present invention. Referring to FIG. 3, the display panel unit 40 receives light of the backlight unit 10 through the double-sided prism film 20 and the switchable diffuser 30, which will be described below, and displays a 2D image or a 3D image (see FIG. 1). The display panel unit 40 is provided with a panel driving unit 41, and the panel driving unit 41 is controlled by the controller 50 to transmit a 2D image or a 3D image according to the 2D mode or the 3D mode. That is, in the 2D mode, the left and right images are synchronized to be transmitted at the left-eye image transmission timing and the right-eye image transmission timing together by the panel driving unit 41 and the display panel 40 displays a 2D image. That is, in the 3D mode, it is synchronized by the panel driving unit 41 such that the left-eye image is transmitted at the left-eye image transmission timing and the right-eye image is transmitted at the right-eye image transmission timing and the display panel unit 40 displays a 3D image. In FIG. 3, Vertical Synchronizing Signal (VSYNC) and Horizontal Synchronizing Signal (HSYNC) refer to vertical and horizontal synchronizations.

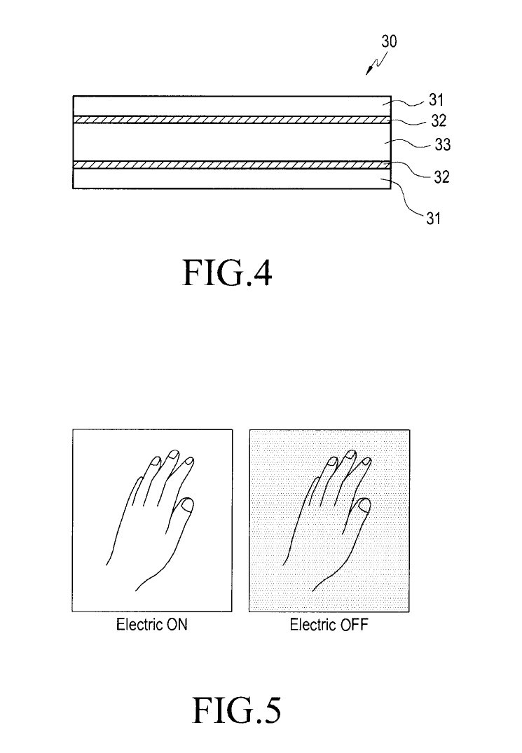

FIG. 4 is a view showing a switchable diffuser of an autostereoscopic display device according to an embodiment of the present invention. FIG. 5 is a view showing an on/off state of the switchable diffuser of the autostereoscopic display device according to the embodiment of the present invention. Referring to FIGS. 4 and 5, the switchable diffuser 30 is located between the double-sided prism film 20 and the display panel unit 40, and is switched on or off according to application of a voltage to change the direction of the view angle of input light and output the light to the display panel unit 40.

The switchable diffuser 30 is provided with a switch 34 for switching on or off the switchable diffuser 30 according to the 2D mode and the 3D mode, and the switch 34 is controlled by the controller 50 (see FIG. 2). The switchable diffuser 30 outputs directional light output from the double-sided prism film 20 while the directional light has different view angles during the 2D mode and the 3D mode to the display panel unit 40.

In the embodiment of the present invention, the switchable diffuser 30 includes a Polymer Dispersed Liquid Crystal (PDLC) including substrates 31, electrodes 32, and a polymer dispersed liquid crystal layer 33. The substrates 31 face each other, and the electrodes 32 are formed on the substrates 31 to face each other. The polymer dispersed liquid crystal layer 33 including a polymer 33a and a liquid crystal 33b is provided between the facing electrodes 32. The substrates 31, on which the electrodes 32 are formed, are formed of a transparent conductive material such that light can be transmitted between the double-sided prism film 20 and the display panel unit 40. An example of the transparent conductive material includes Indium-Tin-Oxide (ITO).

Arrangement of the polymers in the polymer dispersed liquid crystal layer 33 varies according to application of a voltage to the switchable diffuser 30 (see FIGS. 7 and 9). In the 2D mode (see FIG. 7), the polymers 33a are freely arranged, and in the 3D mode (see FIG. 9), the polymers 33a have a layered structure and are regularly arranged. That is, in the 2D mode, electric power to the switchable diffuser 30 is switched off (see the right picture of FIG. 5), and the switchable diffuser 30 acts as a diffuser 30. The polymers of the polymer dispersed liquid crystal layer 33 are dispersed while having a free arrangement. In this state, the light introduced through the substrate 31 of the double-sided prism film 20 is scattered by the polymers, and the light having a wide view angle is output to the display panel unit 40 through the substrate 31. In the 3D mode, electric power to the switchable diffuser 30 is switched on (see the left picture of FIG. 5), and the polymers of the polymer dispersed liquid crystal layer 33 are regularly arranged while forming a layered structure. In this state, the light introduced through the substrate 31 of the double-sided prism film 20 directly transmits the polymer dispersed liquid crystal layer 33, and the light having an existing narrow view angle is output to the display panel unit 40.

Although the switchable diffuser 30 is a PDLC as an example in the embodiment of the present invention, the present invention is not limited thereto, and any configuration, such as a Polymer Stabilized Cholesteric Texture (PSCT) and a Suspend Particle Device (SPD), which can directly transmit input light or scatter and output input light according to switching on or off thereof may be adopted.

The controller 50 controls the switch 34, the panel driving unit 41, and the backlight driving unit 14 according to the 2D mode or the 3D mode. In the 2D mode, the controller 50 controls the switch 34 such that the switchable diffuser 30 is switched off, and controls the panel driving unit 41 and the backlight driving unit 14 such that the left and right-eye images are transmitted together at the left and right-eye image transmission timings of the display panel unit 40.

In the 3D mode, the controller 50 controls the switch 34 such that the switchable diffuser 30 is switched on, and controls the panel driving unit 41 and the backlight driving unit 14 such that the left-eye image is transmitted at a left-eye image transmission timing and the right-eye image is transmitted at a right-eye image transmission timing.

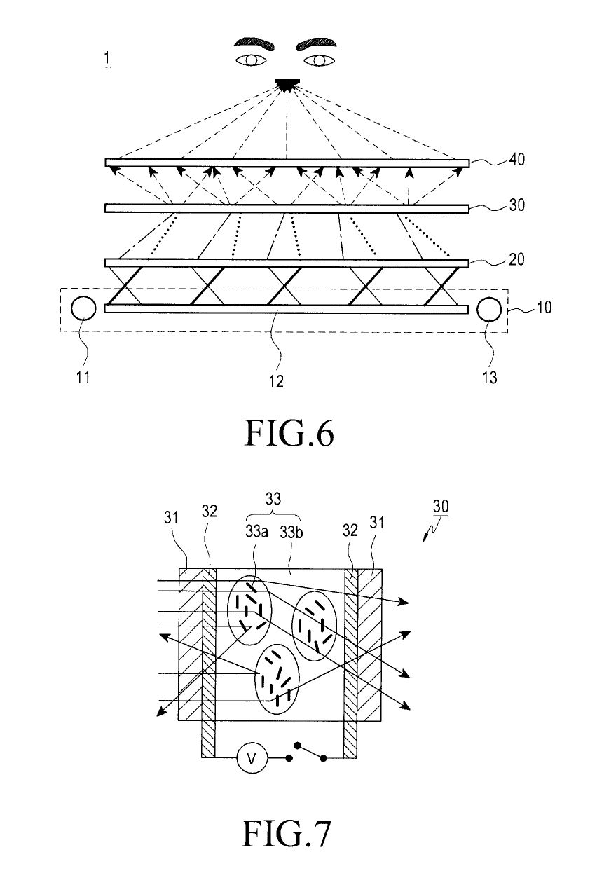

FIG. 6 is a view showing a driving state in the autostereoscopic display device according to the embodiment of the present invention in the 2D mode. FIG. 7 is a view showing a driving state of the switchable diffuser 30 in the autostereoscopic display device according to the embodiment of the present invention in the 2D mode.

Referring to FIGS. 6 and 7, in the 2D mode, the controller 50 controls the switch 34, the panel driving unit 41, and the backlight driving unit 14 according to the 2D mode, and the switch 34, the panel driving unit 41, and the backlight driving unit 14 drive the switchable diffuser 30, the display panel unit 40, and the backlight unit 10 in the 3D mode.

First, the switch 34 switches off the switchable diffuser 30. The panel driving unit 41 synchronizes such that the left and right-eye images are transmitted together at the left and right-eye image transmission timings. The backlight driving unit 14 drives the left and right-eye light sources 11 and 13 according to driving of the panel driving unit 41 irrespective of the 2D mode and the 3D mode.

Accordingly, the switchable diffuser 30 is switched off by the switch 34. A voltage is not applied to the electrodes 32 of the switchable diffuser 30, and the polymers 33a of the polymer dispersed liquid crystal layer 33 are freely arranged. The directional light output through the backlight unit 10 is scattered by the polymers 33a while passing through the polymer dispersed liquid crystal layer 33 of the switchable diffuser 30. The scattered light has a view angle wider than that of the light input to the switchable diffuser 30. Thus, the light having a wide view angle is output to the display panel unit 40. The display panel unit 40 displays a 2D image as the left and right-eye images are transmitted together at the left and right-eye image transmission timings. Thus, the user can view a 2D image which does not generate a black band phenomenon or a Moire phenomenon and has a spatial uniformity, through the display panel unit 40.

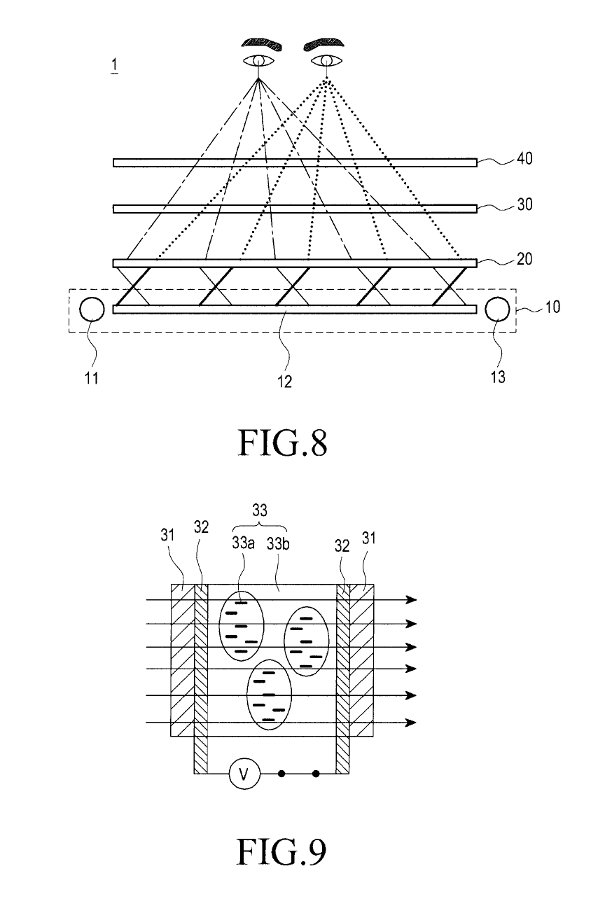

FIG. 8 is a view showing a driving state in the autostereoscopic display device according to the embodiment of the present invention in the 3D mode. FIG. 9 is a view showing a driving state of the switchable diffuser 30 in the autostereoscopic display device according to the embodiment of the present invention in the 3D mode.

Referring to FIGS. 8 and 9, in the 3D mode, the controller 50 controls the switch 34, the panel driving unit 41, and the backlight driving unit 14 according to the 2D mode, and the switch 34, the panel driving unit 41, and the backlight driving unit 14 drive the switchable diffuser 30, the display panel unit 40, and the backlight unit 10 in the 3D mode.

First, the switch 34 switches on the switchable diffuser 30. The panel driving unit 41 synchronizes such that the left-eye image is transmitted at the left-eye image transmission timing and the right-eye image is transmitted at the right-eye image transmission timing. The backlight driving unit 14 drives the left and right-eye light sources 11 and 13 according to driving of the panel driving unit 41 irrespective of the 2D mode and the 3D mode such that the left and right-eye light sources 11 and 13 alternately emit light (see FIG. 9).

A voltage is not applied to the electrodes 32 of the switchable diffuser 30, and the polymers 33a of the polymer dispersed liquid crystal layer 33 between the electrodes 32 are regularly arranged while forming a layered structure. The directional light output through the double-sided prism film 20 directly transmits the polymer dispersed liquid crystal layer 33. Thus, the view angle of the light output from the double-sided prism film is not changed by the switchable diffuser 30, and is output to the display panel unit 40 while having an existing narrow view angle. The left-eye image and the right-eye image are synchronized by the panel driving unit 41 such that the left-eye image is transmitted at a left-eye image transmission timing and the right-eye image is transmitted at a right-eye image transmitting timing, so that the display panel unit 40 displays a 3D image, a resolution of which is not lowered, which does not generate a view reversal phenomenon.

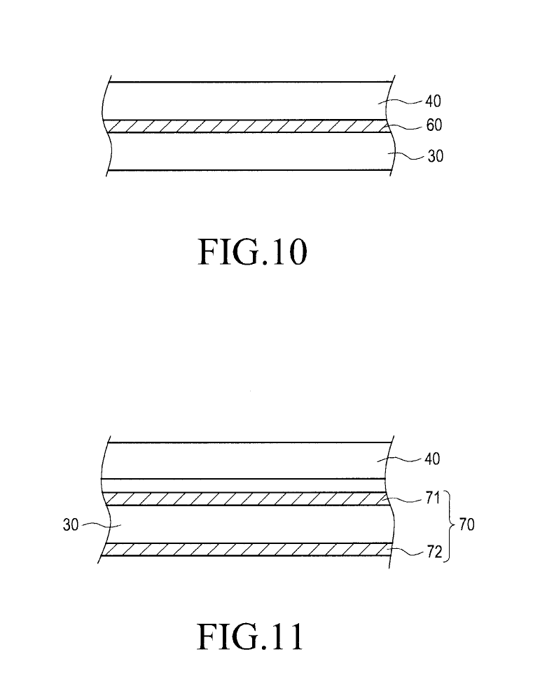

FIG. 10 is a view showing a state in which the switchable diffuser is bonded to the display panel unit by a bonding part in the autostereoscopic display device according to the embodiment of the present invention.

Referring to FIG. 10, the transmissivity of the light emitted from the backlight unit 10 may be lowered by the switchable diffuser 30, or air in the space between the switchable diffuser 30 and the display panel unit 40. Thus, in order to prevent this, a bonding part 60 for attaching the switchable diffuser 30 to a bottom surface of the display panel unit 40 is further provided between the switchable diffuser 30 and the display panel unit 40. The bonding part 60 bonds the switchable diffuser 30 to the display panel unit 40 to prevent the refractive index of the light generated by the switchable diffuser 30 and a space between the switchable diffuser 30 and the display panel unit 40 from being lowered.

Although it is exemplified in the embodiment of the present invention that the bonding part 60 includes an Optically Clear Adhesive (OCA) or a Super View Resin (SVR), the present invention is not limited thereto. That is, any configuration for restricting lowering of the transmissivity of the light finally transmitting the display panel unit 40 by the light emitted from the backlight unit 10 may be adopted. For example, the transmissivity of light can be prevented from being lowered by a coating layer 70, which will be described below, in detail, by anti-reflection or low-reflection coating opposite surfaces or one surface of the switchable diffuser 30.

Although it is exemplified in the embodiment of the present invention that the bonding part 60 bonds the switchable diffuser 30 and the display panel unit 40 to prevent lowering of the transmissivity, the present invention is not limited thereto. For example, various modifications can be made by disposing the bonding part 60 between the switchable diffuser 30 and the display panel unit 40 and anti-reflection or low-reflection coating an opposite surface of the switchable diffuser 30 to prevent lowering of the transmissivity generated between the switchable diffuser 30 and the double-sided prism film 20.

FIG. 11 is a view showing a state in which a coating layer is formed in the switchable diffuser in the autostereoscopic display device according to the embodiment of the present invention. Referring to FIG. 11, coating layers 70 for restricting lowering of the transmissivity of light emitted from the backlight unit 10 is further provided on opposite surfaces of the switchable diffuser 30. Although it has been described in the embodiment of the present invention that the coating layers 70 include a first coating layer 71 formed on an upper surface of the switchable diffuser 30 and a second coating layer 72 disposed on a lower surface of the switchable diffuser 30, the present invention is not limited thereto. Any location or configuration of the coating layer 70 may be adopted, for example, by forming the coating layer 70 on at least one of the upper surface and the lower surface of the switchable diffuser 30 to prevent the transmissivity of light emitted from the backlight unit 10.

Further, it will be exemplified in the embodiment of the present invention that the coating layer 70 includes an Anti-Reflection (AR) coating layer or a Low-Reflection (LR) coating layer.

For example, opposite surfaces of the switchable diffuser 30 may be anti-reflection coated or low-reflection coated, or only an upper surface or a lower surface of the switchable diffuser 30 may be anti-reflection coated or low-reflection coated. Further, any configuration for preventing lowering of the transmissivity of light by the switchable diffuser 30 may be adopted irrespective of the type or form of the coating layer 70. For example, one of the upper surface and the lower surface of the switchable diffuser 30 may be anti-reflection coated and an opposite surface of the switchable diffuser 30 may be low-reflection coated.

Thus, as shown in FIGS. 10 and 11, the switchable diffuser 30 may be bonded to the display panel unit 40 through the bonding part 60 such as an OCA or an SVR, or coating layers 70 may be anti-reflection or low-reflection coated on opposite surfaces of the switchable diffuser 30 to prevent lowering of the transmissivity of light by the switchable diffuser 30.

### TERM LIST PRETEXT

1: Autostereoscopic display device
10: Backlight unit
11: Left-eye light source
12: Light guide plate
13: Right-eye light source
14: Backlight driving unit
20: Double-sided prism film
30: Switchable diffuser
31: Substrate
32: Electrode
33: Polymer dispersed liquid crystal layer
34: Switch
40: Display panel unit
41: Panel driving unit
50: Controller
60: Bonding part
70: Coating layer

1. An autostereoscopic display device comprising:
a backlight unit comprising a left-eye light source, a right-eye light source, and a light guide plate for directionally emitting light of the left-eye light source and the right-eye light source;
a display panel unit for receiving light of the backlight unit and displaying a 2D image or a 3D image;
a double-sided prism film provided to face the backlight unit, for outputting light toward the display panel unit at a predetermined angle; and
a switchable diffuser located between the display panel unit and the double-sided prism film, for outputting light switched on or off according to a 2D mode or a 3D mode to have different view angles.

2. The autostereoscopic display device of claim 1, wherein the backlight unit comprises a backlight driving unit for alternately emitting light of the left-eye light source and the right-eye light source, and wherein the display panel unit further comprises a panel driving unit for synchronizing the left and right-eye images with left and right-eye image transmitting timings.

3. The autostereoscopic display device of claim 2, wherein during the 2D mode, the panel driving unit is driven to transmit the left and right-eye images to the display panel unit together at the left-eye image transmitting timing and the right-eye image transmitting timing, and during the 3D mode, the panel driving unit is driven to transmit the left-eye image to the display panel unit at the left-eye transmitting timing and the right-eye image to the display panel at the right-eye transmitting timing, respectively.

4. The autostereoscopic display device of claim 3, wherein the switchable diffuser comprises:
substrates provided to face each other;
electrodes formed on the substrates to face each other; and
a polymer dispersed liquid crystal layer formed between the electrodes and comprising a polymer and liquid crystal.

5. The autostereoscopic display device of claim 4, wherein if a power source to the switchable diffuser is switched off, light input to the switchable diffuser is scattered by the polymer dispersed liquid crystal layer and light having a wide view angle due to the scattered light displays a 2D image through the display panel unit, and if the power source to the switchable diffuser is switched on, light input to the switchable diffuser directly transmits the polymer dispersed liquid crystal layer along a light emission direction to have a narrow view angle and the light having the narrow view angle displays a 3D image through the display panel unit.

6. The autostereoscopic display device of claim 3, wherein the switchable diffuser further comprises a switch for switching on or off the switchable diffuser according to the 2D mode or the 3D mode.

7. The autostereoscopic display device of claim 6, further comprising a controller for controlling application of a voltage to the backlight driving unit, the switch, and the panel driving unit.

8. The autostereoscopic display device of claim 1, further comprising a bonding part provided between the switchable diffuser and the display panel unit to restrict a refractive index of light emitted from the backlight unit from lowering.

9. The autostereoscopic display device of claim 8, wherein the bonding part comprises an Optically Clear Adhesive (OCA) or a Super View Resin (SVR).

10. The autostereoscopic display device of claim 1, wherein the switchable diffuser further comprises a coating layer for restricting lowering of a refractive index of light emitted from the backlight unit.

11. The autostereoscopic display device of claim 10, wherein the coating layer is formed on at least one surface of the switchable diffuser.

12. The autostereoscopic display device of claim 11, wherein the coating layer comprises an Anti-Reflection (AR) coating layer and a Low Reflection (LR) coating layer.

13. The autostereoscopic display device of claim 1, wherein the switchable diffuser comprises at least one of Polymer Dispersed Liquid Crystal (PDLC), Polymer Stabilized Cholesteric Texture (PSCT), and Suspended Particle Device (SPD).

14. An autostereoscopic display device comprising:
a light emitting member for outputting directional light;
a display panel unit for displaying an 2D or 3D image with the emitted light; and
a switchable diffuser located between the light emitting member and the display panel unit, for outputting light at a view angle of a 2D or 3D image according to switching-on or switching-off thereof.

15. The autostereoscopic display device of claim 14, wherein if a power source to the switchable diffuser is switched off, light input to the switchable diffuser is scattered to a wide view angle such that a 2D image is displayed through the display panel unit, and if the power source to the switchable diffuser is switched on, light input to the switchable diffuser transmits the switchable diffuser along a light emission direction to have a narrow view angle and the light having the narrow view angle displays a 3D image through the display panel unit.

16. The autostereoscopic display device of claim 15, wherein the switchable diffuser comprises at least one of Polymer Dispersed Liquid Crystal (PDLC), Polymer Stabilized Cholesteric Texture (PSCT), and Suspended Particle Device (SPD).

17. The autostereoscopic display device of claim 14, further comprising a controller for controlling the switchable diffuser, the light emitting member, and the display panel unit according to a 2D mode or a 3D mode.

18. The autostereoscopic display device of claim 14, further comprising a bonding part provided between the switchable diffuser and the display panel unit to restrict a refractive index of light emitted from the light emitting member from lowering.

19. The autostereoscopic display device of claim 18, wherein the bonding part comprises an Optically Clear Adhesive (OCA) or a Super View Resin (SVR).

20. The autostereoscopic display device of claim 14, wherein a coating layer for restricting lowering of a refractive index of light emitted from the backlight unit is formed on at least one surface of the switchable diffuser.

21. The autostereoscopic display device of claim 20, wherein the coating layer comprises an Anti-Reflection (AR) coating layer and a Low Reflection (LR) coating.
